(19) United States
(12) Patent Application Publication
(10) Pub. No.: US 2006/0210208 A1
(43) Pub. Date: Sep. 21, 2006

(54) Cryogenic, ultra high-speed rolling bearing

(75) Inventors: Toyohiko Ota, Tokyo (JP); Rei Mihara, Tokyo (JP); Akira Okayasu, Tokyo (JP); Shohei Nakamura, Kuwana-shi (JP); Sichao Chen, Tokyo (JP)

Correspondence Address: GRIFFIN & SZIPL, PC, SUITE PH-1, 2300 NINTH STREET, SOUTH, ARLINGTON, VA, 22204, US

(73) Assignees: Ishikawajima-Harima Heavy Industries Co., Ltd., Koto-ku (JP); NTN Corporation, Nishi-ku (JP); Nikken Coating Industry Co., Ltd., Arakawa-ku (JP)

(21) Appl. No.: 11/353,167

(22) Filed: Feb. 14, 2006

(30) Foreign Application Priority Data
Feb. 14, 2005 (JP) 2005-035359

(51) Int. Cl. F16C 33/44

(52) U.S. Cl. 384/527

(57) ABSTRACT

A cryogenic, ultra high-speed rolling bearing comprises an inner ring 12 fitted onto a rotating shaft rotating at ultra-high speeds under cryogenic conditions, an outer ring 14 concentrically surrounding the inner ring with a space therebetween and fitted onto a fixed portion, a plurality of rolling elements 16 rotatably inserted in the space between the inner ring and the outer ring, and a retainer 20 located between the inner ring and the outer ring to hold the rolling elements at intervals therebetween. The retainer 20 comprises a retainer body 22 having a plurality of pocket holes 21 formed therethrough in a radial direction to contain the rolling elements at intervals therebetween, and a solid lubricant film 24 (pocket hole coating 24A and guideway coating 24B) provided on the inner surfaces of the plurality of pocket holes and a guideway contacting the inner or outer ring and having transfer properties and a low friction coefficient enough for cryogenic conditions.

### BACKGROUND OF THE INVENTION

1. Field of the Invention

The present invention relates to a cryogenic, ultra high-speed rolling bearing used in a cryogenic liquefied gas such as liquid hydrogen, liquid oxygen, or liquefied natural gas.

2. Description of the Related Art

The boiling point of liquid hydrogen, liquid oxygen, or liquefied natural gas (methane) at 1 atmospheric pressure is about −253° C., −183° C., or −162° C., respectively. A bearing used in such a liquefied gas is employed for high speed rotating machinery (for example, turbopump) used in a rocket engine or the like.

The high speed rotating machinery for such a cryogenic liquefied gas requires a very high DN value (bearing bore by rotational speed) as one of the operating conditions of the bearing (for example, two millions or more), so that the retainer used for the rolling bearing needs to be small and lightweight with high strength.

However, oil or grease, typically used as a bearing lubricant, cannot be used for bearings used under such cryogenic conditions. Therefore, bearing retainers made of glass fiber-reinforced composite materials have been proposed as cryogenic bearing retainers having self-lubricating properties and usable for high DN-value purposes, and are already in use as turbopump bearings for rocket engines (for example, see Japanese Examined Patent Publication No. H02-20854).

Cryogenic bearings without retainers have also been proposed for the same or similar purposes (for example, see Japanese Patent Laid-Open No. 2002-147462).

Japanese Examined Patent Publication No. H02-20854 entitled “Manufacturing Method for Bearing Retainer Made of Glass Fiber-Reinforced Composite Material” discloses a manufacturing method for a bearing retainer made of a glass fiber-reinforced composite material formed by reinforcing a self-lubricating material with glass fiber. In this method, the bearing retainer material made of glass fiber-reinforced composite is mechanically machined and the glass fiber is dissolved and removed from the machined surface with a finishing agent. In an embodiment of this publication, polytetrafluoroethylene (PTFE) is used as the self-lubricating material.

On the other hand, as shown in FIGS. 1A and 1B, Japanese Patent Laid-Open No. 2002-147462 entitled “Rolling Bearing” discloses a rolling bearing having spherical shaped separators 55, each of which is arranged between adjacent balls 54 in a raceway between an inner ring 52 and an outer ring 53. In an embodiment of this publication, the spherical shaped separator 55 is made up of core and outer shell parts with the outer shell made of a PTFE high polymer material.

As mentioned above, a rolling bearing (hereinafter, called a “cryogenic, ultra high-speed rolling bearing”) for high speed rotating machinery (for example, turbopump) used for a rocket engine or the like in a cryogenic liquefied gas such as liquid hydrogen, liquid oxygen, or liquefied natural gas needs to: 1) maintain a low friction coefficient and abrasion resistance required at cryogenic temperatures between about −260° C. and −160° C. without use of a fluid lubricant such as oil and grease; and 2) have applicability for such ultra-high rpm use that the DN value (bearing bore by rotational speed) is about two millions or more and the rotational speed is about eighty thousands rpm or more.

The cryogenic, ultra high-speed rolling bearing manufactured by the method disclosed in Japanese Examined Patent Publication No. H02-20854 meets the above-mentioned requirements, and is already in practical use in a space development project in Japan. However, there are problems that this manufacturing method requires complicated manufacturing processes and increases manufacturing costs.

On the other hand, the rolling bearing disclosed in Japanese Patent Laid-Open No. 2002-147462 has the possibility of reducing manufacturing costs to a large extent, but it may result in an reduction in radial load available because half the balls located in the raceway between the inner ring and the outer ring do not contribute to the bearing action.

### SUMMARY OF THE INVENTION

The present invention has been made to solve the above-described problems. In other words, it is an object of the present invention to provide, as an alternative to the conventional cryogenic, ultra high-speed rolling bearings, a cryogenic, ultra high-speed rolling bearing capable of: 1) maintaining a low friction coefficient and abrasion resistance required at cryogenic temperatures between about −260° C. and −160° C. without use of a fluid lubricant such as oil and grease; 2) being applied for such ultra-high rpm use that the DN value is about two millions or more and the rotational speed is about eighty thousands rpm or more; and 3) reducing manufacturing costs.

According to the present invention, there is provided a cryogenic, ultra high-speed rolling bearing comprising:

an inner ring fitted onto a rotating shaft rotating at ultra-high speeds under cryogenic conditions;

an outer ring concentrically surrounding the inner ring with a space therebetween and fitted onto a fixed portion;

a plurality of rolling elements rotatably inserted in the space between the inner ring and the outer ring; and

a retainer located between the inner ring and the outer ring to hold the rolling elements at intervals therebetween,

wherein the retainer comprises

a retainer body, which is a ring-shaped member concentric with the inner ring and the outer ring and has a plurality of pocket holes formed therethrough in a radial direction to contain respective rolling elements at intervals therebetween, and

a solid lubricant film provided on the inner surfaces of the plurality of pocket holes and a guideway contacting the inner or outer ring and having transfer properties and a low friction coefficient enough for cryogenic temperature conditions.

According to one preferred embodiment of the present invention, the retainer body is made of a light metal material, which withstands high temperatures between about 300° C. and 500° C., and after this high temperature processing, which gains relative strength capable of withstanding ultra-high rotational speeds at cryogenic temperatures, and

the solid lubricant film is a fluorocarbon resin formed on the surface of the retainer body and baked at the above-mentioned high temperature.

The solid lubricant film also contains an adequate amount of anti-wear additive to enhance abrasion resistance.

It is preferable that the solid lubricant film provided on the inner surfaces of the pocket holes is a high-transfer fluorocarbon resin coated film with excellent lubricity and high transfer properties, while the solid lubricant film provided on the guideway contacting the inner or outer ring is an abrasion-resistant fluorocarbon resin coated film with excellent lubricity and abrasion resistance.

According to the structure of the present invention, the solid lubricant film is provided on the inner surfaces of the pocket holes of the retainer body and the guideway contacting the inner or outer ring. The solid lubricant film has transfer properties and a low friction coefficient enough for cryogenic temperature conditions, so that solid lubricant film transfers to the surfaces of the rolling elements due to contact when the bearing is in operation. This makes it possible to maintain a low friction coefficient and abrasion resistance required in cryogenic environments without use of a fluid lubricant such as oil or grease.

The retainer body is made of a light metal material, which withstands high temperatures between about 300° C. and 500° C., and after the high temperature processing, which gains relative strength capable of withstanding ultra-high rotational speeds at cryogenic temperatures, so that it can be applied for ultra-high rpm use at eighty thousands rpm or more at which the DN value (bearing bore by rotational speed) reaches about two millions or more.

Further, the solid lubricant film is a fluorocarbon resin formed on the surface of the retainer body and baked at the above-mentioned high temperature. This makes it possible to enhance the adhesive strength, and hence abrasion resistance, of the solid lubricant film and the retainer body.

Furthermore, the fluorocarbon resin is coated and baked on the surface of the light metal material to obtain a retainer of desired performance. Therefore, the manufacturing processes are simpler than the conventional products, thereby making it possible to reduce manufacturing costs to a large extent.

Furthermore, the solid lubricant film contains an adequate amount of anti-wear additive, thereby making it possible to further enhance abrasion resistance.

In particular, the solid lubricant film provided on the inner surfaces of the pocket holes is a high-transfer fluorocarbon resin coated film with excellent lubricity and transfer properties, while the solid lubricant film provided on the guideway contacting the inner or outer ring is an abrasion-resistant fluorocarbon resin coated film with excellent lubricity and abrasion resistance. This makes it possible to select the optimum coatings different in function as lubricants for the pocket parts and the guideway, respectively.

The other objects and advantageous features of the invention will become clearer from the following description of the preferred embodiment taken in conjunction with the accompanying drawings.

### BRIEF DESCRIPTION OF THE DRAWINGS

FIGS. 1A and 1B show the structure of a conventional rolling bearing disclosed in Japanese Patent Laid-Open No. 2002-147462.

FIGS. 2A, 2B, and 2C show the structure of a cryogenic, ultra high-speed rolling bearing according to one preferred embodiment of the present invention.

FIG. 3 is a line chart showing characteristic lines of pin friction coefficients obtained in Example 1 according to the present invention.

FIG. 4 is a bar chart for comparing the amounts of pin abrasive wear obtained in Example 1 according to the present invention.

FIG. 5 is a line chart showing characteristic lines of pin friction coefficients obtained in Example 2 according to the present invention.

FIG. 6 is a line chart for comparing the amounts of pin abrasive wear obtained in Example 2 according to the present invention.

FIG. 7 is a bar chart showing the characteristics of metal contact ratios obtained in Example 2 according to the present invention.

FIG. 8 is a sectional view showing the structure of a performance tester for the cryogenic, ultra high-speed rolling bearing according to the present invention.

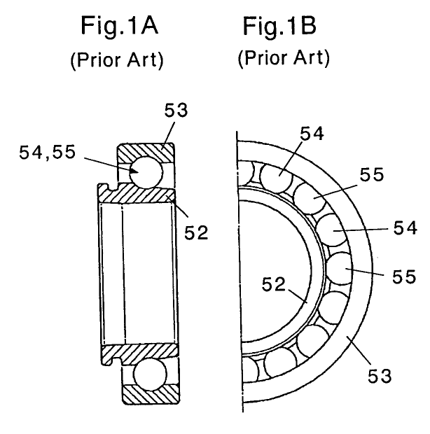

### DESCRIPTION OF THE PREFERRED EMBODIMENT

A preferred embodiment of the present invention will be described below with reference to the accompanying drawings. Common elements in each of the drawings are given the same reference numerals and will not be described repeatedly.

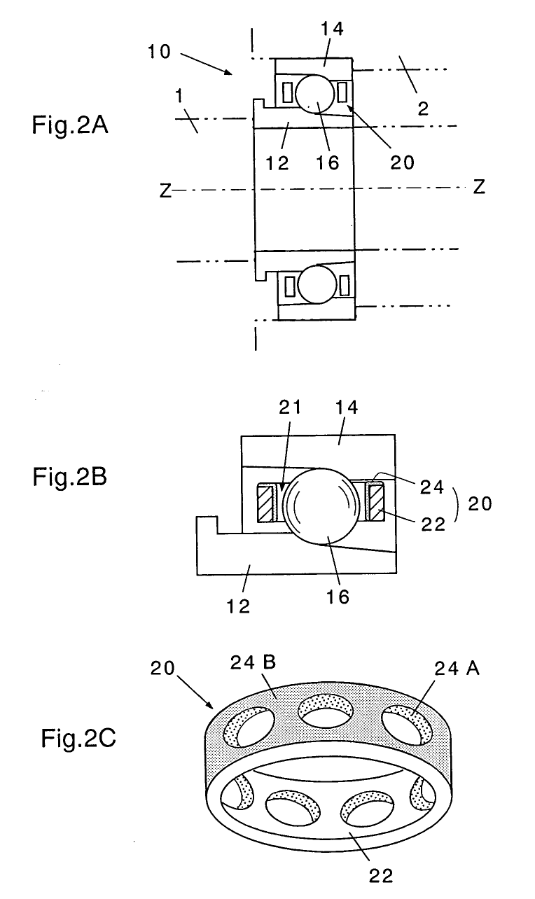

FIGS. 2A, 2B, and 2C show the structure of a cryogenic, ultra high-speed rolling bearing according to the embodiment of the present invention. Among these figures, FIG. 2A is a side sectional view, FIG. 2B is an enlarged fragmentary view, and FIG. 2C is a perspective view of a retainer.

As shown in FIG. 2A, a cryogenic, ultra high-speed rolling bearing 10 according to the embodiment of the present invention includes an inner ring 12, an outer ring 14, rolling elements 16, and a retainer 20.

The inner ring 12 is fitted onto the rotating shaft 1 that rotates about a Z-Z axis at ultra-high speeds under cryogenic conditions. In this application, the term “cryogenic temperatures” means temperatures between −260° C. and −160° C., while the term “ultra-high speeds” means that DN value is about two millions or more and the rotational speed is about eighty thousands rpm or more.

The rotating shaft 1 is, for example, a turbpump for a cryogenic liquefied gas such as liquid hydrogen, liquid oxygen, or liquefied natural gas; it is driven by the vaporized cryogenic liquefied gas and cooled by the cryogenic liquefied gas itself. The rotating shaft 1 is made of a nickel-based superalloy, such as an Inconel material, having high fatigue strength under cryogenic conditions.

An interference is provided between the inner ring 12 and the rotating shaft 1 under cryogenic temperature and ultra-high speed conditions so that no speed difference or slip will occur between the inner ring 12 and the rotating shaft 1 even if a centrifugal force acts on the inner ring 12 due to ultra-high rotation.

The outer ring 14 concentrically surrounds the inner ring 12 with a space therebetween, and fitted onto a fixed portion 2. The outer ring 14 is made of martensitic stainless steel (SUS440) or the like in consideration of the use of the rolling bearing in cryogenic environments.

In the embodiment, the rolling elements 16 are multiple (9 to 10) spherical-shaped balls rotatably inserted in a space between the inner ring 12 and the outer ring 14. It is recommended that the rolling elements 16 are made of ceramic (for example, Si₃N₄). Alternatively, it can also be made of martensitic stainless steel (SUS440C).

In this embodiment, the bearing 10 is an angular ball bearing, but the present invention is not limited to this type, and it may also be a roller bearing using rollers as its rolling elements.

The retainer 20 is a ring-shaped member concentric with the inner ring 12 and the outer ring 14, and is located between the inner ring 12 and the outer ring 14 to hold the rolling elements 16 at intervals therebetween.

As shown in FIGS. 2B and 2C, the retainer 20 is made up of a retainer body 22 and a solid lubricant film 24.

The retainer body 22 has a plurality of pocket holes 21 formed therethrough in a radial direction to contain respective rolling elements 16 at intervals therebetween. In this embodiment, the retainer body 22 is a hollow cylinder-shaped solid member, made of a light metal material, which withstands high temperatures between about 300° C. and 500° C., and after this high temperature processing, which gains relative strength capable of withstanding ultra-high rotational speeds at cryogenic temperatures. A corrosion-resistant aluminum alloy such as A5056 aluminum alloy can be used as the light metal material.

The retainer can be formed by mixing Teflonat (registered trademark) resin with strength enhancing additives in view of lubricity alone, but such a retainer is not enough for high speed bearing because of lack of material strength (relative strength=tensile strength/specific gravity).

Thus the retainer body 22 is made of a lightweight aluminum alloy having high relative strength at cryogenic temperatures with less damage to the other parts (the inner ring 12 and the outer ring 14) in the bearing during high-speed rotation. The use of aluminum alloy can also improve manufacturing precision and high-speed rotational accuracy, compared to the use of resin.

In this embodiment, the solid lubricant film 24 is a coating film provided on the inner surfaces of the pocket holes 21 and a guideway (outer surface) contacting the outer ring 14. If the guideway is formed on the inner surface of the retainer body 22, the solid lubricant film 24 is provided on the inner surface contacting the inner ring 12.

The solid lubricant film 24 (coating film) is a fluorocarbon resin formed on the surface of the retainer body 22 and baked at a high temperature between about 300° C. and 500° C., so that the solid lubricant film 24 has transfer properties and a low friction coefficient enough for cryogenic conditions. The solid lubricant film 24 contains an adequate amount of anti-wear additive to enhance abrasion resistance.

Particularly, the solid lubricant film 24A (pocket hole coating) on the inner surfaces of the pocket holes 21 is transferred onto the rolling elements 16 by friction with the rolling elements 16 to contribute to the lubrication between the rolling elements 16 and the intended frictional parts of the rolling bearing between the inner and outer rings. Therefore, the coating agent in these parts needs to have a low friction coefficient and excellent transfer properties, and is selected in view of balance with its abrasion resistance performance for life extension. The life of the coating is determined by the coating thickness.

Thus the solid lubricant film (pocket hole coating) 24A on the inner surfaces of the pocket holes is a high-transfer fluorocarbon resin coated film with excellent lubricity and high transfer properties, which has a film thickness (preferably 0.1 mm or more) determined depending on the required life span.

The guideway is guided in contact with the bore of the outer ring of the bearing to rotate at high speed. Therefore, the solid lubricant film 24B (guideway coating) on the guideway contributes to lubrication on contact. In this case, since the guideway and the outer ring could come into too strong contact with each other due to a slight unbalance of the retainer or radial load, it needs to have a sufficiently low friction coefficient and appropriate abrasion resistance performance.

It is recommended that the solid lubricant film 24B (guideway coating) on the guideway contacting the inner ring or the outer ring is an abrasion-resistant fluorocarbon resin coated film with excellent lubricity and abrasion resistance.

Thus, it is recommended that the lubricant coating is formed using a material suited to the function of the pocket part or the guideway, respectively.

After coating, the guideway is polished to enhance the precision of clearance with the bore as the guideway of the outer ring of the bearing. The improved accuracy of the shape of the retainer can stabilize the behavior of the retainer during high-speed rotation and hence prevent heat generation due to excessive internal friction.

### EXAMPLE 1

### Comparative Test 1 on Coating Materials

In order to evaluate coating materials, a comparative test was done on PTFE with a small amount of anti-wear additive (TP1), PTFE with a medium amount of anti-wear additive (TP2), PTFE with a large amount of anti-wear additive (TP3), and TP3 with a low-temperature sliding additive (TP4) . The small, middle, and large amounts of anti-wear additive mean that the additive ratio of the same anti-wear additive increases in this order. The sliding additive different from the anti-wear additive was added to TP4 in an adequate amount.

The test was carried out on retainer materials TP1 to TP4 set as pins in a pin-on-disk type transfer tester at a cryogenic temperature (−196° C.) . In this test, the ratio of metal contact (%) was also determined from electric resistance between a ball and a rotating plate in the transfer tester. The test results are shown in FIGS. 3, 4, 5 and Table 1 (under cryogenic conditions).

TABLE 1
Cryogenic Temperature (−196° C.)

| | | Pin | | | |
|---|---|---|---|---|---|
| | | Friction | | abrasive | |
| NO | Retainer Material | Coefficient | Transfer | wear | Evaluation |
| 1 | PTFE w/Anti-Wear | Tiny | Bad | Small | Medium |
| | Additive (Small) | | | | |
| 2 | PTFE w/Anti-Wear | Small | Good | Medium | Good |
| | Additive (Medium) | | | | |
| 3 | PTFE w/Anti-Wear | Tiny | Bad | Small | Medium |
| | Additive (Large) | | | | |
| 4 | PTFE w/Anti-Wear | Small | Medium | Small | Medium |
| | Additive (Large) | | | | |
| | and Low- | | | | |
| | Temperature | | | | |
| | Sliding Additive | | | | |

FIG. 3 is a line chart showing variations in pin friction coefficient at the cryogenic temperature. It is apparent from this chart that all of TP1 to TP4 have low friction coefficients equivalent to conventionally proven products.

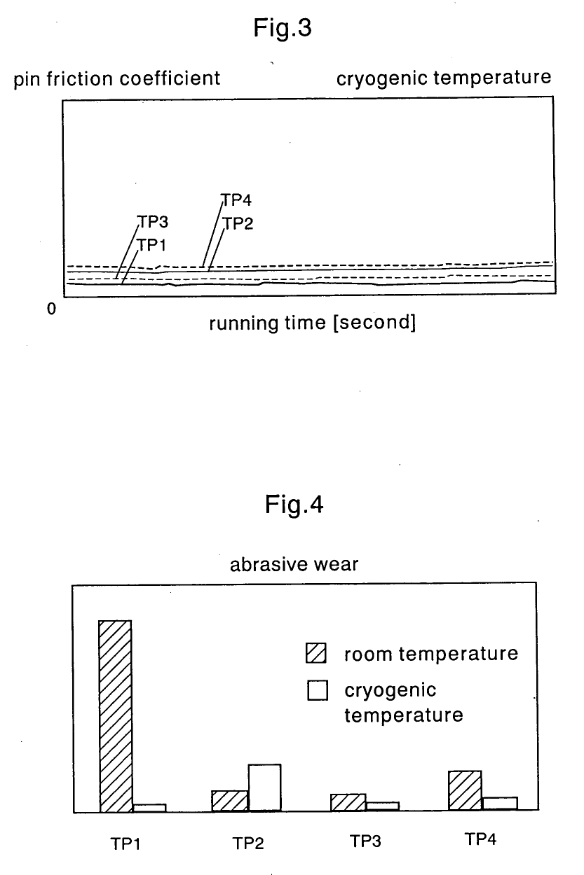

FIG. 4 is a bar chart for comparing the amounts of abrasive wear on the test pins at room and cryogenic temperatures. It is found from this chart that, though the amount of abrasive wear on TP1 is excessive at the room temperature, those on TP1 to TP4 at the cryogenic temperature are all small enough to match or better than conventionally proven products.

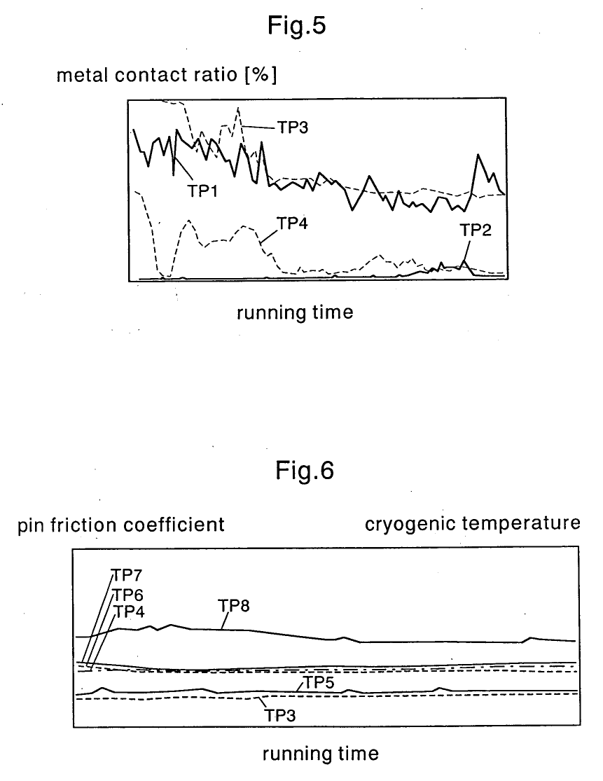

FIG. 5 is a line chart showing variations in ratio of metal contact. It is apparent from this chart that the transfer property of TP2 is equivalent to that of conventionally proven products, but the transfer properties of the others are inferior to those of the conventional.

The above-mentioned results confirm that TP2 has performance equivalent to conventionally proven products in terms of all the friction coefficient, the transfer property, and the amount of abrasive wear.

### Example 2

### Comparative Test 1 on Coating Materials

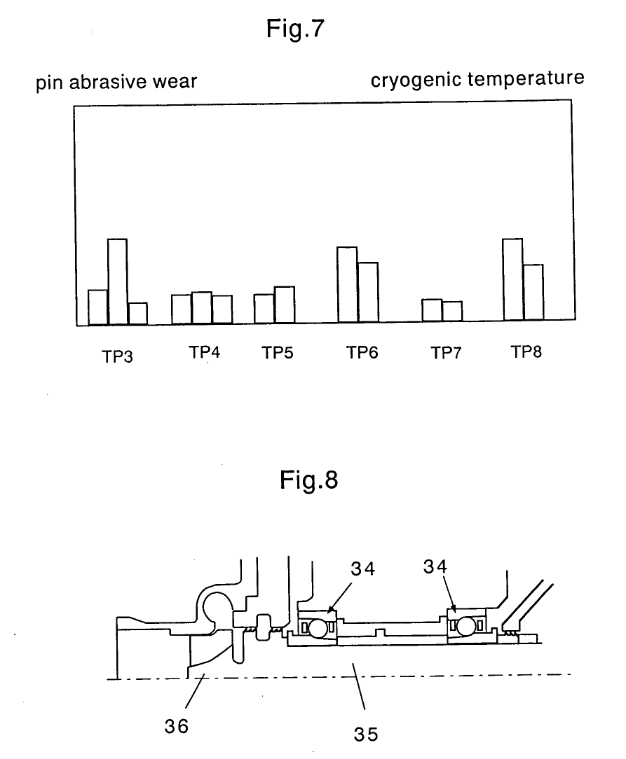

In order to further evaluate coating materials, four kinds of PTFE-based test materials (TP5 to TP8) with anti-wear additive and the like added thereto were prepared and the same test as on TP3 and TP4 was carried out at a cryogenic temperature (−196° C.). The test results are shown in FIGS. 6 and 7.

FIG. 6 is a line chart showing variations in pin friction coefficient at the cryogenic temperature. It is found from this chart that all of TP4 to TP7, except TP8, have low friction coefficients equivalent to conventionally proven products.

FIG. 7 is a bar chart for comparing the amounts of abrasive wear on the test materials at the cryogenic temperature. It is found from this chart that, though the amounts of abrasive wear on TP3, TP6, and TP8 are relatively large, those on TP5 and TP7 are better than conventionally proven products.

The above-mentioned results confirm that TP5 and TP7 has performance equivalent to conventionally proven products in terms of all the friction coefficient, and the amount of abrasive wear.

### Example 3

### Performance TEST on Bearing

The bearing of the present invention was actually rotated at ultra-high speeds under cryogenic conditions to test its performance.

FIG. 8 is a sectional view of the structure of a performance tester to test the performance of the cryogenic, ultra high-speed rolling bearing according to the present invention. In this tester, two sets of sample bearings 34 are incorporated with a radial turbine 36 provided at an end of an ultra high-speed rotating shaft 35. The radial turbine 36 was driven by gasified liquid hydrogen (at about −253° C.) and the bearing was cooled by liquid hydrogen.

The bearing 34 of the present invention was made up by making the retainer body 22 of A5056 aluminum alloy, forming a coating film corresponding to TP2 in Example 1 on the inner surfaces of the pocket holes 21 and the outer circumference of the guideway, baking the coating film, and polishing the outer circumference of the guideway to predetermined dimensions while remaining the coated inner surface of the pocket holes and inner surface of retainer unpolished.

Then, after the ultra high-speed rotating shaft 35 was rotated at a speed of about one hundred thousand rpm for 180 seconds in liquid hydrogen of −253° C., the bearing 34 was disassembled into parts to test each of the parts. The test results show that the amounts of abrasive wear on the inner surfaces of the pocket holes and the outer circumference of the guideway are small enough for the bearing of the present invention to maintain a low friction coefficient and abrasion resistance required in cryogenic environments without use of a fluid lubricant such as oil or grease like the conventional cryogenic, ultra high-speed rolling bearings.

As described above, according to the present invention, the retainer body 22 is made of an aluminum alloy, which can obtain high rigidity for cryogenic, ultra high-speed bearing with high relative strength (about three times the strength of the conventionally used retainer material and about five times the strength of Teflon(registered trademark) based strength enhancing material).

Further, the bearing has strength enough to overcome circumferential stress caused in the pocket position by centrifugal force and the ball speed variation (BSV) between the rolling elements.

Furthermore, since the retainer is made of a light metal, the accuracy of the shape of the retainer can be improved, thereby stabilizing the behavior of the retainer during high-speed rotation and hence preventing heat generation due to excessive internal friction.

Furthermore, since the solid lubricant film is formed on the surface of the retainer body, the coating agent for the pocket parts can be selected by placing emphasis on lubricity and transfer properties, while the coating agent for the guideway can be selected by placing emphasis on lubricity and abrasion resistance, thus selecting optimum coatings different in function as lubricants for the pocket parts and the guideway, respectively.

It should be noted that the present invention is not limited to the above-described examples and embodiment, and various changes and modifications can be made without departing from the scope of the invention.

What is claimed is:

1. A cryogenic, ultra high-speed rolling bearing comprising:
an inner ring fitted onto a rotating shaft rotating at ultra-high speeds under cryogenic conditions;
an outer ring concentrically surrounding the inner ring with a space therebetween and fitted onto a fixed portion;
a plurality of rolling elements rotatably inserted in the space between the inner ring and the outer ring; and
a retainer located between the inner ring and the outer ring 14 to hold the rolling elements at intervals therebetween,
wherein said retainer comprises
a retainer body, which is a ring-shaped member concentric with the inner ring and the outer ring and has a plurality of pocket holes formed therethrough in a radial direction to contain the rolling elements at intervals therebetween, and
a solid lubricant film provided on the inner surfaces of the pocket holes and a guideway contacting the inner or outer ring, and having transfer properties and a low friction coefficient enough for cryogenic conditions.

2. The bearing according to claim 1 wherein
said retainer body is made of a light metal material, which withstands high temperatures between about 300° C. and 500° C., and after the high temperature processing, which gains relative strength capable of withstanding ultra-high rotational speeds at cryogenic temperatures, and
said solid lubricant film is a fluorocarbon resin formed on the surface of the retainer body and baked at the above-mentioned high temperature.

3. The bearing according to claim 2 wherein said solid lubricant film contains an adequate amount of anti-wear additive to enhance abrasion resistance.

4. The bearing according to claim 2 wherein said solid lubricant film provided on the inner surfaces of the pocket holes is a high-transfer fluorocarbon resin coated film with excellent lubricity and high transfer properties, while the solid lubricant film provided on the guideway contacting the inner or outer ring is an abrasion-resistant fluorocarbon resin coated film with excellent lubricity and abrasion resistance.
